(19) United States
(12) Patent Application Publication
(10) Pub. No.: US 2007/0085363 A1
(43) Pub. Date: Apr. 19, 2007

(54) Console assembly for a vehicle

(75) Inventors: Alan Sturt, West Bloomfield, MI (US); Jason Gamache, Romeo, MI (US); Jerome David Joler, Rochester Hills, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/163,295

(22) Filed: Oct. 13, 2005

(51) Int. Cl. B60R 7/00

(52) U.S. Cl. 296/37.8

(57) ABSTRACT

A console assembly for a vehicle includes a console housing securable to a floor of a passenger seating area configured to receive and store one or more items. A lower console module extends generally horizontally adjacent the console housing and includes a seating portion for supporting an occupant and a storage area having one or more storage compartments provided on an opposing side of the lower console module. The lower console module is adjustable between a seated position and a deployed position wherein the storage area of the lower console module is exposed to the passenger seating area of the vehicle. An upper console module is disposed adjacent the lower console module. The upper console module is adjustable between a generally vertical position supporting an occupant and a generally horizontal position.

### BACKGROUND OF THE INVENTION

1. Field of the Invention

The present invention relates generally to a console assembly for a passenger seating area of a vehicle.

2. Background Art

Vehicle manufacturers continue to develop storage containers and devices for the passenger compartments of vehicles to accommodate occupant's personal items and automotive components. Several current storage containers are designed to fit within specified areas of the passenger compartment and allow limited access to items stored therein.

Many automotive vehicles include a center console or other storage device disposed between the driver and passenger seats in the front passenger compartment of the vehicle. These consoles typically comprise a console base either secured to the floor or pivotally connected between the seats, a storage cavity formed in the console base to retain items during travel and an armrest pivotally connected to the console base extending generally horizontally across the storage cavity.

One limitation of traditional floor console systems is that vehicle manufacturers cannot maximize seating capacity in the vehicle. For example, if a floor console is placed between a pair of passenger seats, a third seat option cannot be disposed between the seats. It would be advantageous to provide a console assembly for a passenger seating area of a vehicle wherein the console assembly provides both a seating area for passengers and storage compartments for retaining items placed in the vehicle.

### SUMMARY OF THE INVENTION

The present invention provides a console assembly disposed between a pair of passenger seats in a passenger seating area. The console assembly comprises a console housing securable to a floor of the passenger seating area configured to receive and store one or more items.

A lower console module or seat bottom extends generally horizontally adjacent the console housing. The lower console module includes a seating portion for supporting an occupant and a storage area having one or more storage compartments provided on an opposing side of the lower console module. The lower console module is adjustable between a seated position and a deployed position wherein the storage area of the lower console module is exposed to the passenger seating area of the vehicle.

An upper console module or seat back is disposed adjacent the lower console module. The upper console module is adjustable between a generally vertical position and a generally horizontal position. The upper console includes a seating portion for supporting an occupant and an armrest disposed opposite the seating portion.

Other features and advantages of the present invention will be readily appreciated and better understood after reading the subsequent description when considered in connection with the accompanying drawings.

### BRIEF DESCRIPTION OF THE DRAWINGS

FIG. 1 is a perspective view of a passenger seating area of a vehicle having a console assembly in accordance with the present invention;

FIG. 2 is a rear perspective view of the passenger seating area of a vehicle;

FIG. 3 is a rear perspective view of the passenger seating area with a lower console module of the console assembly shown in a concealed position;

FIG. 4 is a rear perspective view of the passenger seating area with the console seat bottom and dashboard shown in a utility position;

FIG. 5 is a side plan view showing the console assembly in the concealed position;

FIG. 6 is a side plan view showing the lower console module of the console assembly in the deployed position; and

FIG. 7 is a side plan view showing the seat back and seat bottom of the console assembly pivoted forward in accordance with the present invention.

### DETAILED DESCRIPTION OF THE PREFERRED EMBODIMENT(S)

Referring now to the Figures, a console assembly for use in the passenger seating area 10 of a motor vehicle in accordance with the present invention is disclosed. It is understood that the console assembly may be a stand alone console which provides seating options for the passenger seating area. Alternatively, the console assembly may be used in either the front or rear passenger seating areas. The console assembly may also comprise a center seat arrangement. For purposes of this disclosure, the console assembly will be installed in the front passenger seating area.

In the following description, various operating parameters and components are described for a number of constructed embodiments. These specific parameters and components are included as examples and are not meant to be limiting.

In a preferred aspect of the present invention, console assembly comprises a center seat arrangement for a vehicle. The console assembly is disposed between a pair of passenger seats 12, 14 and includes a lower console module or seat bottom 16 and an upper console module or seat back 18. The seat back 18 is rotatable relative to the passenger seats 12, 14 about pivot axis 20. In one aspect of the present invention, the seat back is pivotally mounted to a portion of the console assembly. In another aspect of the present invention, one or more mounting arms extend upward from the vehicle floor or console assembly to receive and secure the seat back.

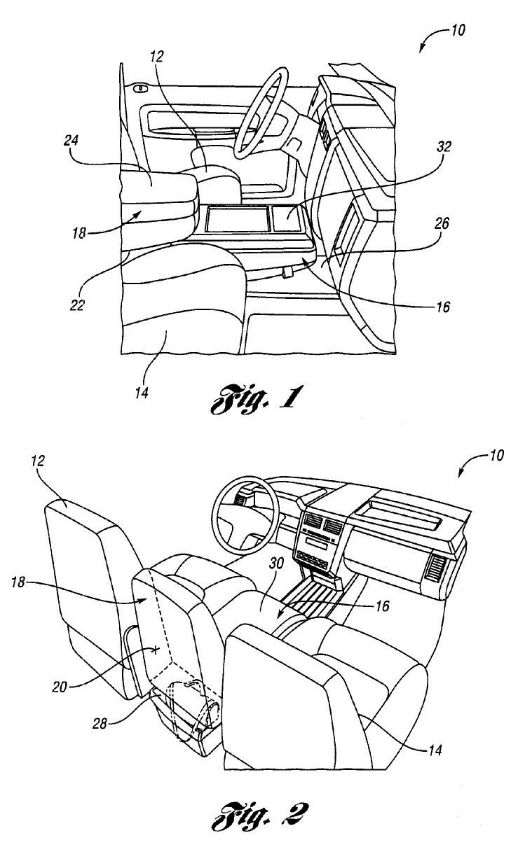

Referring now to FIG. 1, the seat back 18 includes a covered or appearance surface 22 and an armrest 24 disposed opposite the covered portion 22. Appearance surface 22 may include a cushion configured to a passenger when the appearance surface 22 is in an elevated or raised position generally aligned with the seat backs of the adjacent passenger seats 12, 14. Appearance surface 22 may be covered by any standard seating material, such as leather, vinyl, cloth or the like to provide an appearance finish for the seating area.

Armrest 24 is configured to support an occupant's appendage or one or more items thereon. In one aspect of the present invention, the armrest is covered with a standard seating material to coordinate with the seating area of vehicle. In another aspect of the present invention, a polymeric insert is placed on armrest. The polymeric insert may include molded recesses adapted to receive and store various items, including liquid containers, sunglasses and the like.

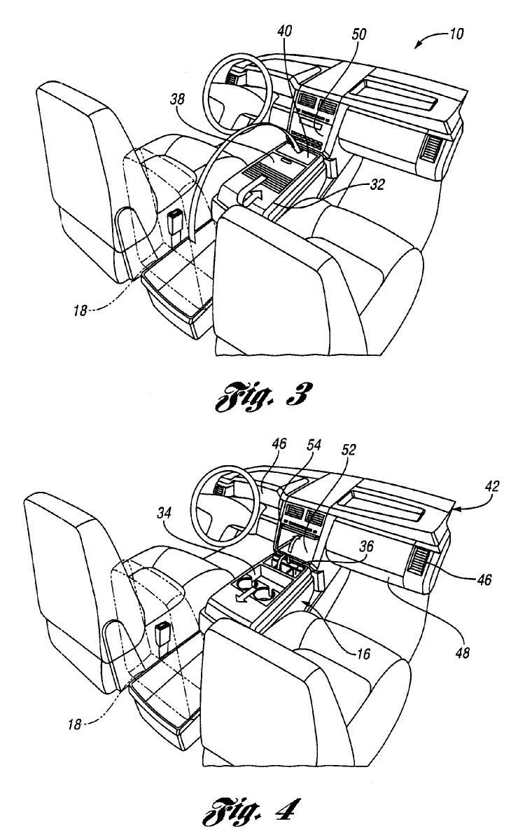

Referring now to FIGS. 2 and 3, seat bottom 16 is pivotally mounted adjacent a console housing 26 extending along the floor of a passenger seating area of a vehicle. Console housing 26 may include a floor or transmission tunnel having one or more storage compartments or recesses 28 formed therein configured to receive and secure passenger personal items, such as purses, cell phones or sunglasses. Storage compartments 28 are accessible from either the front or rear passenger seating areas. It is also contemplated that vehicle components, such as garage door openers, media components and the like may be positioned within the console housing 26.

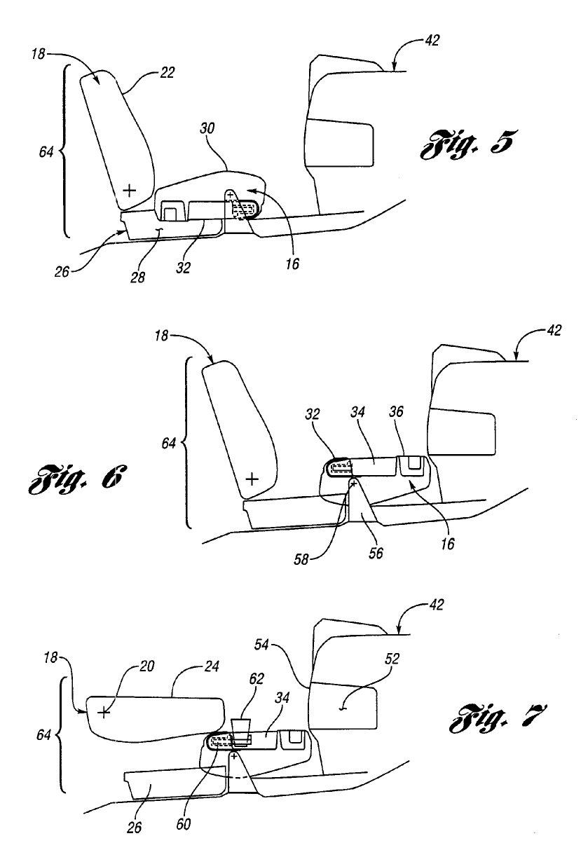

Seat bottom 16 includes a seating portion 30 and a storage area 32 disposed opposite seating portion 30. Seating portion 30 preferably includes a cushion covered by a standard seating material, such as leather, vinyl, cloth or the like similar to that covering seat back appearance surface 22 to provide an appearance finish for the seating area. Seat bottom 16 is movable between a seating position, as illustrated in FIGS. 2 and 5, and a deployed position, as shown in FIGS. 1, 3, 6 and 7. A description of the adjustment of the seat bottom 16 is discussed in greater detail below.

Referring now to FIGS. 3 and 4, seat back 18 is shown in a generally vertical position in phantom positioned between seats 12, 14 and seat bottom 16 is pivoted forward to expose the storage area 32 on the seat bottom 16. Storage area 32 includes one or more storage compartments 34, 36. Storage compartments may be configured to receive and secure various passenger personal items. A description of the storage compartments will be provided in greater detail below. A door or cover 38, 40 is provided over each storage compartment 34, 36 to enclose items stored therein. As illustrated in FIG. 3, door 38 is received with storage compartment 34 and is slidably movable between a closed position and an opened position. Door 40 is pivotally connected to storage compartment 36 such that the door may be rotated between a closed position and an opened position exposing the storage compartment 36 for access by occupants of the passenger seating area of the vehicle.

FIG. 4 illustrates the console assembly in a deployed or utility position. Seat bottom 16 is rotated forward such that the storage area 32 is exposed to the passenger seating area. Storage area 32 is disposed adjacent a vehicle dashboard 42. Vehicle dashboard 42 is configured to receive a number of vehicle components, including ventilation system controls and vents 44, audio/video controls, driver information gauges 46 and storage bins, such as a glove box 48. It is understood that various other features or components may be installed in the vehicle dashboard.

In one aspect of the present invention, when lower console module or seat bottom 16 is moved from a seating or concealed position to a deployed position, storage area 32 on seat bottom 16 is exposed to the passenger seating area. It is contemplated that features on the storage area 32, such as the trim and storage compartments 34, 36 will align with aesthetic and functional features provided on the vehicle instrument panel to provide an integrated appearance surface. In this manner, occupants in the passenger seating area would view the lower console module or seat bottom 16 as a continuation of the instrument panel such that the combination would give the appearance of an integrated center console arrangement.

In another aspect of the present invention, audio/video controls 50, shown in FIG. 3, are pivotally mounted to dashboard 42 adjacent a storage cavity 52 in dashboard. Controls 50 may be moved from a closed position wherein controls 50 are substantially flush mounted in an opening 54 in dashboard 42 corresponding with storage cavity 54 and an opened position exposing the storage cavity to the passenger seating area. This concept is disclosed in copending U.S. patent application Ser. No. 11/087,951, filed Mar. 23, 2005, entitled “Control Panel Assembly for a Vehicle,” which is hereby incorporated by reference.

Referring additionally now to FIGS. 5-7, a description of the deployment of the seat bottom and seat back of the console assembly 64 in accordance with the present invention is described in greater detail. Both the seat bottom 16 and seat back 18 are movable between a seating position and a deployed position to provide additional functionality for the passenger seating area of the vehicle.

The console assembly 64 in FIGS. 2 and 5 illustrate seat bottom 16 and seat back 18 in a seating position. In this position, both seat bottom 16 and seat back 18 are configured to receive a passenger as a third passenger seat. Seat back 18 extends generally vertically relative to the vehicle floor such that the appearance surface 22 of seat back 18 faces towards dashboard 42. The seating portion 30 of seat bottom 16 faces generally upward into the passenger seating area and is disposed adjacent seat back 18, while storage portion 32 is stowed adjacent storage compartments 28 in console housing 26. It is contemplated that storage portion 32 of the seat bottom may be shaped to be received within the storage compartments 28 in console housing 26 such that compartments 28 provide additional structural support for seat bottom 16.

FIGS. 3 and 6 show the seat bottom 16 of console assembly 64 moved to a deployed position. Seat back 18 remains in a generally vertical position disposed between the passenger seats (not shown). Seat bottom 16 is pivotally mounted to one or more brackets 56 disposed on opposing sides of storage compartments 28 of console housing 26. It is also understood that the seat bottom may be pivotally mounted to the console housing or the adjacent passenger seats. Seat bottom 16 pivots about pivot axis 58 such that the storage area 32 of seat bottom 16 is positioned adjacent dashboard 42 and is exposed to the passenger seating area of the vehicle, thereby exposing storage compartment 34, 36 in storage area 32. In this position, seat bottom 16 is configured to operate as a floor console arrangement.

FIGS. 4 and 7 shows the console assembly 64 in a fully deployed position, wherein the seat back 18 is rotated forward adjacent the seat bottom 16 about pivot axis 20 to expose the armrest 24 of seat back 18. Both seat bottom 16 and seat back 18 extend generally horizontally through the passenger seating area and cooperate with console housing 26 to provide a center console arrangement for the occupants of the vehicle seating area. Storage compartment 34 includes a beverage holder 60 configured to receive and secure a container 62.

In one aspect of the present invention, door 38, shown in FIGS. 3 and 4, is moved to an opened position, exposing beverage holder 60 in storage compartment 34. Beverage holder 60 is retractable between a stowed position received in the seat bottom 16 and a deployed position extending away from the storage compartment sidewall. In another aspect of the present invention shown in FIG. 4, the beverage holder is integrally formed in the storage compartment 34. When seat bottom 16 is rotated forward adjacent dashboard 42, the audio/video control panel 50 is pivoted away from the opening 54 in dashboard 42 to expose storage recess 52. Storage recess 52 cooperates with the storage area 32 of seat bottom 16 to extend the storage capacity of the console assembly 64.

It is also contemplated that the seat back may include a storage compartment formed therein. In this aspect of the present invention, the armrest portion would include a closeout section which extends over the storage compartment. The closeout section includes a latch which engages a corresponding catch on the storage compartment to secure the closeout section to the seat back. The closeout section can be easily arranged to pivot about the front, rear or either side of the seat back in view of design and aesthetic requirements.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A console assembly configured for use in a passenger seating area of a vehicle, the console assembly comprising:
a lower console module extending generally horizontally adjacent a floor of the passenger seating area, the lower console module having a seating portion for supporting an occupant and a storage area provided on an opposing side of the lower console module; and
an upper console module disposed adjacent the lower console module adjustable between a generally vertical position and a generally horizontal position, the upper console having a seating portion for supporting an occupant,
wherein the lower console module is adjustable between a seated position wherein the seating portion is disposed adjacent the upper console module and a deployed position wherein the storage area is exposed to the passenger seating area of the vehicle.

2. The console assembly of claim 1 wherein the console assembly is disposed between a pair of passenger seats in the passenger seating area.

3. The console assembly of claim 1 wherein the console assembly is configured to provide a single seat in the passenger seating area.

4. The console assembly of claim 1 further comprising a console housing securable to a floor of the passenger seating area having a base, a front surface, opposing side surfaces and a rear surface defining a transmission tunnel and one or more storage recesses therein.

5. The console assembly of claim 4 wherein the lower console module is pivotally mounted to the console housing.

6. The console assembly of claim 1 wherein the storage area of the lower console module and an instrument panel disposed adjacent the passenger seating area cooperate to provide an integrated center console.

7. The console assembly of claim 1 wherein the storage area of the lower module housing further comprises one or more storage compartments.

8. The console assembly of claim 7 further comprising one or more doors disposed above the one or more storage compartments movable between an open position and a closed position.

9. The console assembly of claim 7 further comprising a container holder formed into the one or more storage compartments.

10. The console assembly of claim 1 wherein a storage recess provided in a dashboard cooperates with the lower storage module.

11. The console assembly of claim 10 wherein a vehicle control panel is pivotally mounted to the dashboard adjacent the storage recess and is movable between a closed position extending at least partially across the storage recess and an open position.

12. The console assembly of claim 1 wherein the upper console housing further comprises an armrest disposed opposite the seating portion which is configured to extend into the passenger seating area when the upper console housing is moved to the generally horizontal position.

13. A console assembly disposed between a pair of passenger seats in a passenger seating area, the console assembly comprising:
a console housing securable to a floor of the passenger seating area configured to receive and store one or more items;
a lower console module extending generally horizontally adjacent the console housing movable between a seated position and a deployed position, the lower console module having a seating portion for supporting an occupant and a storage area having one or more storage compartments provided on an opposing side of the lower console module; and
an upper console module disposed adjacent the lower console module adjustable between a generally vertical position wherein a seating portion of the upper console module is configured to support an occupant and a generally horizontal position,
wherein the storage area of the lower console module is exposed to the passenger seating area of the vehicle when moved to the deployed position.

14. The console assembly of claim 13 wherein the console housing further comprises a base, a front surface, opposing side surfaces and a rear surface defining a transmission tunnel and one or more storage recesses therein.

15. The console assembly of claim 13 wherein the lower console module is pivotally mounted to the console housing.

16. The console assembly of claim 13 wherein the storage area of the lower console module and an instrument panel disposed adjacent the passenger seating area cooperate to provide an integrated center console.

17. The console assembly of claim 13 further comprising one or more doors disposed above the one or more storage compartments movable between an open position and a closed position.

18. The console assembly of claim 13 wherein a storage recess provided in a dashboard cooperates with the lower storage module.

19. The console assembly of claim 13 wherein the upper console housing further comprises an armrest disposed opposite the seating portion which is configured to extend into the passenger seating area when the upper console housing is moved to the generally horizontal position.

20. A center seat arrangement disposed between a pair of passenger seats in a passenger seating area, the arrangement comprising:
a seat bottom extending generally horizontally adjacent a floor of the passenger seating area, the seat bottom having a seating portion for supporting an occupant and a storage area provided on an opposing side of the lower console module; and
a seat back disposed adjacent the seat bottom having a seating portion for supporting an occupant adjustable between a generally vertical position and a generally horizontal position,
wherein the seat bottom is adjustable between a seated portion and a deployed position wherein the storage area is exposed to the passenger seating area of the vehicle.
